(19) United States
(12) Patent Application Publication
(10) Pub. No.: US 2006/0243148 A1
(43) Pub. Date: Nov. 2, 2006

(54) Flexible digital printing plates and process of digital printing

(76) Inventors: Mikhail Laksin, Boonton, NJ (US); Subhankar Chatterjee, Hampton, NJ (US); Wojciech A. Wilczak, Jersey City, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/118,866

(22) Filed: Apr. 29, 2005

(51) Int. Cl. B41N 1/00; B41M 1/00

(52) U.S. Cl. 101/483; 101/395; 101/401.1; 430/306

(57) ABSTRACT

Disclosed is a process for preparing a digital printing plate for flexographic and letterpress printing consisting of irradiating a polymeric material covering the plate to cause collapse of a non-image area on said plate.

### FIELD OF THE INVENTION

The present invention relates to a novel flexible digital printing plate and a process to make the same wherein the plates contain collapsed polymeric material as non-image areas and are suitable for flexographic and letterpress printing.

### BACKGROUND OF THE INVENTION

CTP (computer to plate and computer to press) technology is the fastest growing segment of the printing market that is clearly going to dominate entire pre-press across the Graphic Art field. When CTP is applied to the offset plate, both—“to plate” and “to press” technology already exists. The best example of “to press” technology are Quickmaster D1, Karat etc. presses. In this case, waterless offset plates are used. Plate imaging step is short (less than 9 minutes for a set of 4 process colors on D1), because the plate's layer that has to be ablated does not typically exceed 1 micron. This technology is used in commercial printing and recently in news printing but not in flexible packaging. Selective wetting of the plate's image and non-image areas by the ink is a very sensitive and complex process that makes both litho and waterless offset printing very complicated. It is even more difficult to use offset printing on non-absorbent plastic substrates.

Flexographic and letterpress printing is much more robust because the image area is raised over the non-image area. Print quality of letterpress and UV flexo which utilizes higher viscosity liquid inks is equal or better than offset, and both technologies are perfectly suitable for printing on flexible firms.

“To plate” digital technology is also known for raised photopolymer plates. This is a rather lengthy process that requires first photochemical “building” of a plate base and then digital imaging and developing, utilizing wet developer. Obviously, this technology cannot be implemented in the “to press” mode.

### SUMMARY OF THE INVENTION

The present invention provides a process for preparing a digital printing plate for flexographic and letterpress printing comprising irradiating a polymeric material covering the plate to cause collapse of a non-image area on said plate.

The present invention also provides a digital printing plate for flexographic and letterpress printing comprising polymeric material covering the plate and collapsed in areas to form a non-image area on said plate.

Other objects and advantages of the present invention will become apparent from the following description and appended claims.

### DETAILED DESCRIPTION OF THE INVENTION

It has been surprisingly discovered that a process of digital formation of the raised plate, which can take place directly on the printing press in a very short time can be accomplished without using any wet chemicals. The plate material comprises a polymer film, prefarably a micro-foamed polymer film containing at least 20% air by volume. Preferably, the polymeric film is selected from the group consisting of polyethylene, polypropylene, polystyrene, polyester, polyurethane, polycarbonate, polyvinyl chloride, epoxy, polyamide, polyamide, polyisocyanurate, polyacrylics, rubber, melamine and a blend thereof.

Upon exposure to irradiation such as IR laser beam, the polumer film rapidly collapses forming a cavity in the non-image area of the plate. The depth of the plate relief is controlled by the foam size, nature of the polymer, exposure time and laser power. Since polymer to foam ratio can be very small, the same or similar amount of IR energy and time that are needed to ablate a thin but hard ink receptive layer of the offset plate would cause a significant cavity in the foamed polymer film.

It is also beneficial to use heat sensitive polymers that would shrink at the high temperature of IR beam further increasing the depth of the plate relief. Any ink systems can be used with such plate, however, energy curable (UV or EB), especially wet trappable EB curable flexo or letterpress inks are the most suitable to meet many end use flexible packaging requirements.

The printing plate of the present invention allows a digital press and printing process design for the flexible packaging market with raised plated imaged directly on press in a very short time. Micro-foamed plate material is a key element of this technology, which allows an image to be send directly to flexographic or letterpress press, printing plate generated in a very short time without causing a major press down time and printing a packaging material on selected substrate using energy curable inks that will be ready for shipment immediately after printing.

The invention has been described in terms of preferred embodiments thereof, but is more broadly applicable as will be understood by those skilled in the art. The scope of the invention is only limited by the following claims.

1. A process for preparing a digital printing plate for flexographic and letterpress printing comprising irradiating a polymeric material covering the plate to cause collapse of said irradiated polymeric material into a non-image area on said plate.

2. The process of claim 1, wherein said polymeric material is selected from the group consisting of polyethylene, polypropylene, polystyrene, polyester, polyurethane, polycarbonate, polyvinyl chloride, epoxy, polyamide, polyamide, polyisocyanurate, polyacrylics, rubber, melamine and a blend thereof.

3. The process of claim 1, wherein said process takes place on a printing press.

4. The process of claim 1, wherein said polymeric material is temperature sensitive and reduces volume upon exposure to laser beam irradiation.

5. The process of claim 1, wherein said polymeric material contains at least 20% air by volume in the form of a foam.

6. The process of claim 1, wherein said printing plate is suitable for printing with energy curable liquid or paste inks.

7. The process of claim 6, wherein said energy curable inks are UV or EB curable.

8. The process of claim 6, wherein said energy curable inks are actinic irradiation curable inks.

9. A digital printing plate for flexographic and letterpress printing comprising polymeric material covering the plate and collapsed in areas to form a non-image area on said plate according to the process of claim 1.

10. The printing plate of claim 9, wherein said polymeric material is selected from the group consisting of polyethylene, polypropylene, polystyrene, polyester, polyurethane, polycarbonate, polyvinyl chloride, epoxy, polyamide, polyamide, polyisocyanurate, rubber, melamine and a blend thereof.

11. The printing plate of claim 9, wherein said polymeric material is temperature sensitive and reduces volume upon exposure to laser beam irradiation.

12. The printing plate claim 9, wherein said polymeric material contains at least 20% air by volume in the form of a foam.

13. The printing plate claim 9, wherein said printing plate is suitable for printing with energy curable liquid or paste inks.

14. The printing plate of claim 12, wherein said energy curable inks are UV or EB curable.

15. The printing plate of claim 13, wherein said energy curable inks are actinic irradiation curable inks.

16. A digital printing process comprising transferring energy curable inks from the digital printing plate of claim 9 onto a substrate.

17. The process of claim 16, wherein said energy curable inks are liquid or paste inks.

18. The process of claim 16, wherein said energy curable inks are UV or EB curable.

19. The process of claim 16, wherein said energy curable inks are actinic irradiation curable inks.

20. The process of claim 16, wherein said transfer is carried out flexographically with anilor roller.

21. The process of claim 16, wherein said transfer is carried out with help of letterpress multi-roller printing head.
